(19) United States
(12) Patent Application Publication
(10) Pub. No.: US 2017/0291190 A1
(43) Pub. Date: Oct. 12, 2017

(54) ASSEMBLY FOR A CARRIER FOR CARRYING A CAULK CARTRIDGE AND CAULKING GUN

(71) Applicant: SIANG SYUAN FU ENTERPRISE CO., LTD., Changhua County (TW)

(72) Inventor: HUNG-CHIH HUNG, Changhua County (TW)

(21) Appl. No.: 15/633,156

(22) Filed: Jun. 26, 2017

Related U.S. Application Data
(63) Continuation-in-part of application No. 15/088,933, filed on Apr. 1, 2016.

(30) Foreign Application Priority Data
Apr. 2, 2015 (TW) 104110790

(51) Int. Cl. B05C 17/005; B05C 17/01

(52) U.S. Cl. CPC B05C 17/00596; B05C 17/0123

(57) ABSTRACT

A caulking gun includes a carrier for carrying a caulk cartridge, an assembly for the carrier, a gun body and a push rod. The assembly is for disposing between the gun body and the carrier and includes a seat portion and a spacing portion. The seat portion includes a seat wall for being connected between the gun body and the carrier. The spacing portion includes an annular projection portion configured to be abutted between the gun body and the carrier in a manner that the gun body and the carrier are rotatable relative to each other. The carrier is rotatably connected with the gun body through the assembly, and the carrier is rotatable relative to the annular projection portion. The push rod is movably connected to the gun body and disposed through the assembly, and extends into the carrier.

### BACKGROUND OF THE INVENTION

### Field of the Invention

This application is a Continuation-in-Part of application Ser. No. 15/088,933, filed on Apr. 1, 2016, for which priority is claimed under 35 U.S.C. §120; and this application claims priority of Application No. 104110790 filed in Taiwan on Apr. 2, 2015 under 35 U.S.C. §119, the entire contents of all of which are hereby incorporated by reference.

### DESCRIPTION OF THE PRIOR ART

Generally, caulk is usually used to fix gap, crack, crevice in buildings and decoration. The caulk is contained in a caulk cartridge, and a caulking gun can be used to push the caulk cartridge to extrude the caulk out from the conical outlet of the caulk cartridge. The conventional caulking gun, mainly, includes a gun body, a limitation portion and a carrier. The limitation portion is swingably attached to and cooperates with the gun body. An elastic portion is disposed in the gun body, and a push rod disposed through the gun body can be actuated to push the caulk cartridge to extrude the caulk out from the conical outlet of the caulk cartridge. However, the conventional caulking gun has following disadvantages. There are fixation parts disposed between the carrier and the gun body. However, to prettify the caulking gun, the gun body and the carrier each are usually coated with lacquer layer, colorful layer or the like, in which the lacquer layer, colorful layer or the like has a thickness, and lacquer layers, colorful layers or the like manufactured in different processes have different thicknesses. It is noted that if the lacquer layer, colorful layer or the like on the carrier has a sufficient thickness, there will exist a gap between the carrier and caulking gun, so that the carrier is unstable and easy to rock. If the lacquer layer, colorful layer or the like on the carrier has an overthick thickness, the carrier will be tightly connected to the gun body. As a result, the carrier is therefore non-rotatable relative to the gun body, the orientation of the outlet of the caulk cartridge cannot be adjusted, and thus it is inconvenient to apply the caulking gun for various requirements (such as two edges of a wall perpendicular to each other, or the like).

The present invention is, therefore, arisen to obviate or at least mitigate the above mentioned disadvantages.

### SUMMARY OF THE INVENTION

An object of the present invention is to provide an assembly for a carrier for carrying a caulk cartridge and a caulking gun, in which the carrier and a gun body can be stably connected with each other without rocking, and the carrier is allowed to be orientationally rotated and frictionally positioned.

To achieve the above and other objects, an assembly for a carrier of a caulking gun, for disposing between a gun body of the caulking gun and a carrier for carrying a caulk cartridge, including: a seat portion, including a seat wall, for being connected between the gun body and the carrier; a spacing portion, including an annular projection portion, the annular projection portion configured to be abutted between the gun body and the carrier in such a manner that the gun body and the carrier are rotatable relative to each other.

To achieve the above and other objects, a caulking gun is provided, including the assembly for the carrier of the caulking gun, further including: a gun body; a carrier, rotatably connected with the gun body through the assembly for the carrier of the caulking gun, the carrier being rotatable relative to the annular projection portion; a push rod, movably connected to the gun body, disposed through the assembly for the carrier of the caulking gun, extending into the carrier.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an explosion drawing of a first preferred embodiment of the present invention;

FIG. 2 is a partial cross-sectional view of the first preferred embodiment of the present invention;

FIG. 3 is an enlarged drawing of FIG. 2;

FIGS. 4 and 5 are drawings showing the first preferred embodiment of the present invention in use;

FIG. 6 is an explosion drawing of a second preferred embodiment of the present invention;

FIG. 7 is a partial cross-sectional view of the second preferred embodiment of the present invention;

FIG. 8 is an enlarged drawing of FIG. 7;

FIG. 9 is an explosion drawing of a third preferred embodiment of the present invention;

FIG. 10 is a drawing showing a spacing portion of the third preferred embodiment of the present invention;

FIG. 11 is a drawing showing a seat portion of the third preferred embodiment of the present invention;

FIG. 12 is a perspective view of the third preferred embodiment of the present invention;

FIG. 13 is a side view of the third preferred embodiment of the present invention; and

FIG. 14 is an enlarged drawing of FIG. 13.

### DETAILED DESCRIPTION OF THE PREFERRED EMBODIMENTS

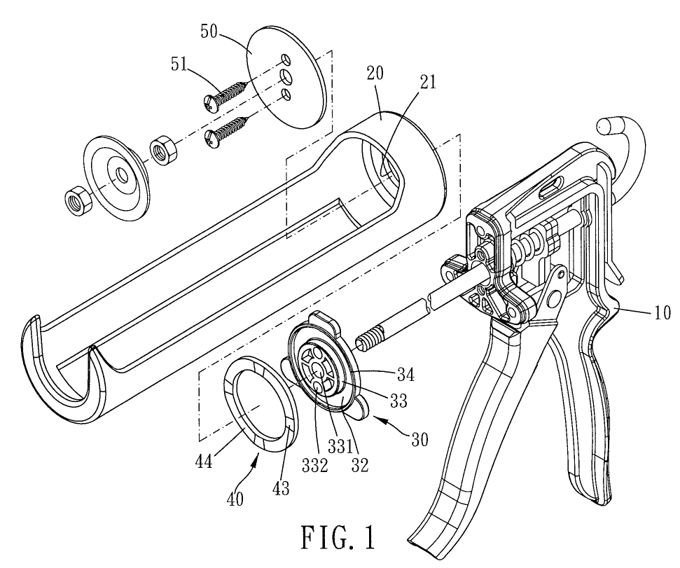

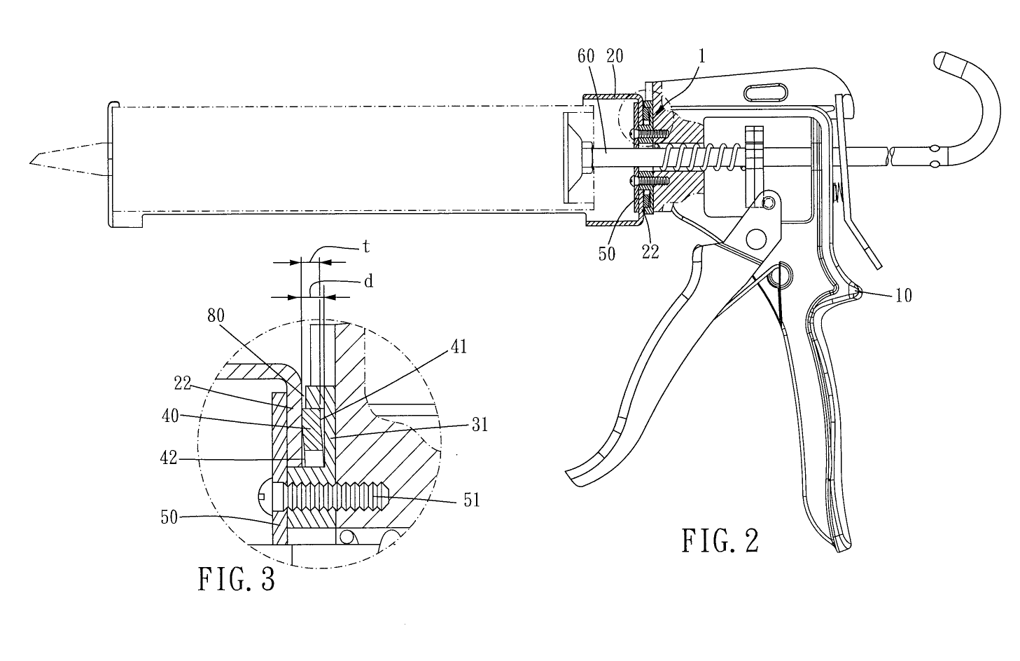

FIGS. 1-5 show an assembly 1 for a carrier of a caulking gun according to a first preferred embodiment of the present invention. The assembly 1 for the carrier of the caulking gun is for disposing between a gun body 10 of the caulking gun and a carrier 20 for carrying a caulk cartridge. The assembly 1 for the carrier of the caulking gun includes a seat portion 30 and a spacing portion 40. The seat portion 30 includes a seat wall 31 and is for being connected between the gun body 10 and carrier 20. The spacing portion 40 includes at least one projection portion. The at least one projection portion is disposed on the seat wall for being abutted between the gun body 10 and the carrier 20 in such a manner that the gun body 10 and the carrier 20 are rotatable relative to each. Preferably, the spacing portion 40 includes at least three of the projection portions, and the at least three projection portions are circumferentially spaced on the seat wall 31 and for the carrier 20 rotatable abutment of the carrier thereagainst. Whereby, the magnitude of frictional contact between the carrier 20 and the gun body 10 is controllable and adjustable, the carrier 20 can be stably held without rocking, and the carrier 20 is allowed to be orientationally rotated and frictionally positioned by utilizing the assembly 1 for the carrier of the caulking gun.

The seat portion 30 may be integrally formed as a part of the gun body 10. The spacing portion 40 may be integral with the seat portion 30 and may be made of/from metal, plastic, silicon, rubber or a combination thereof. The at least three projection portions are preferably elastically deformable (including elastically deformable in material or in assembled-structure). In this embodiment, the seat portion 30 is a plate body and includes a recess 32, and the seat portion 30 may be made of/from metal, plastic, silicon, rubber or a combination thereof. The spacing portion 40 is an elastic metal sheet and includes a first side 41 and a second side 42 opposite to each other. The first side 41 is received in the recess 32 and abutted against the seat wall 31. The second side 42 includes four projection portions 43 and a plurality of depression portions 44 alternatively arranged with the four projection portions 43. The four projection portions 43 protrude beyond the seat portion 30. Specifically, the recess 32 is an annular groove, and the spacing portion 40 is a waved-ring plate. The waved-ring plate includes the four projection portions 43 and the depression portions 44, and the depression portions 44 are spaced on the seat wall 31. The four projection portions 43 are for abutting against the carrier 20 in non-fully-surface contact. Preferably, the waved-ring plate has a thickness t equal to less than a depth d of the annular groove, thus providing sufficient tolerance for deformation of the spacing portion 40. It is noted that each of the at least three projection portions may be an individual member attached to the seat portion. The at least one projection portion may be abutted against the gun body. The at least one projection portion may be a single extending projection which is, for example, arched, annular, elongated, polygonal or the like. The spacing portion may be polygonal or in any shape.

A middle of the seat portion 30 facing the second side 42 includes a tubular body 33. The tubular body 33 includes a central hole 331 and a plurality of voids 332 around the central hole 331, thus reducing weight and providing slightly deformability. The tubular body 33 is for corresponding to a through hole 21 of the carrier 20, and the waved-ring plate is disposed around the tubular body 33. The seat portion 30 further includes an outer flange 34 around the tubular body 33. Corresponding to the second side 42, the tubular body 33 protrudes beyond the outer flange 34, and the four projection portions 43 protrudes beyond the tubular body 33, so as to ensure that the spacing portion 40 and the carrier 20 contact with each other in multiple points and they are stably assembled without rocking.

In this embodiment, the assembly 1 for the carrier 20 of the caulking gun further includes a clamp member 50 and two fasteners 51 (it is possible to use at least one fastener; a single fastener and the clamp member may be integrally formed of one piece), and the fastener 51 is screw. The clamp member 50 and the spacing portion 40 are for being disposed by two side of an axially-facing wall 22 of the carrier 20, and the two fasteners 51 are disposed through the clamp member 50 and for being fixed to the gun body 10. Specifically, the two screws 51 are disposed through the clamp member 50, the axially-facing wall 22 of the carrier 20 and a tubular wall of the tubular body 33 (such as parts of the voids 332) and fixed to the gun body 10.

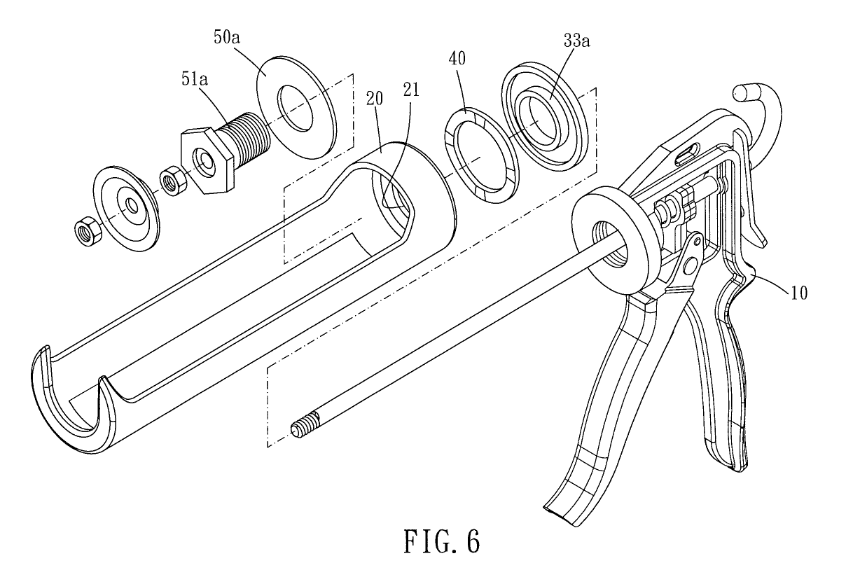

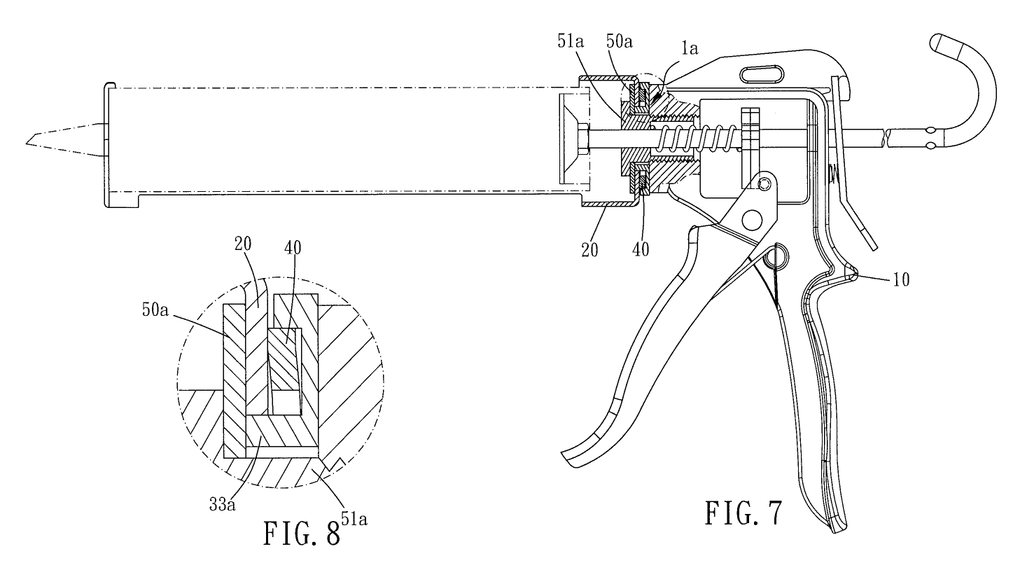

As shown in FIGS. 6-8, in a second embodiment, an assembly 1a for a carrier of a caulking gun includes a hollow bolt 51a, the hollow bolt 51a is coaxially disposed through the clamp member 50a, the through hole 21 of the carrier 20, the spacing portion 40 and the tubular body 33a and fixed to the gun body 10. It is noted that the fastener and the clamp member may be integrally formed of one piece.

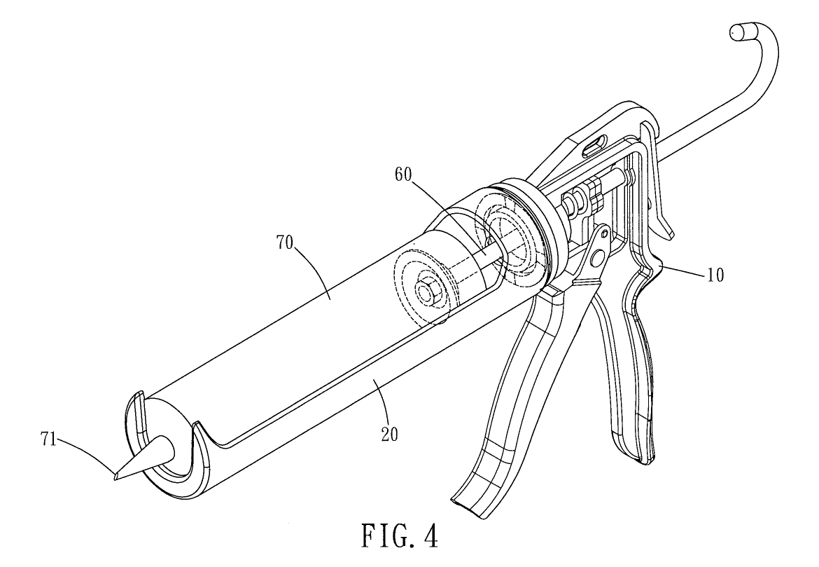

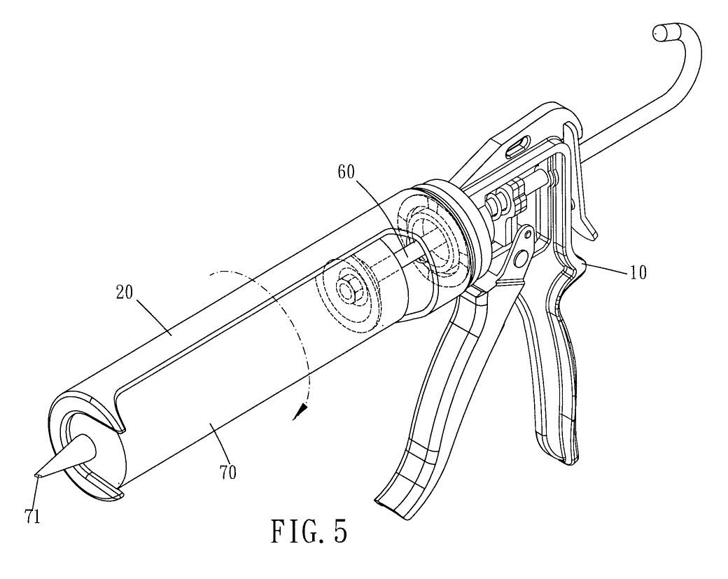

As shown in FIGS. 1-5, a caulking gun is further provided. The caulking gun includes an assembly 1 for a carrier of a caulking gun mentioned in the first embodiment (or may be assembly 1a in the second embodiment), a gun body 10, a carrier 20 and a push rod 60. The carrier 20 is rotatably connected with the gun body 10 through the assembly 1 for the carrier of the caulking gun and, and the carrier 20 is slidable relative to the projection portion 43. The push rod 60 is movably connected to the gun body 10, and the push rod 60 is disposed through the assembly 1 for the carrier of the caulking gun and extends into the carrier 20 for pushing a caulk cartridge 70 supported by the carrier 20 to discharge caulk. Preferably, the projection portions 43 abut against the axially-facing wall 22 of the carrier 20, the tubular body 33 abuts against the clamp member 50, and the outer flange 34 and the axially-facing wall 22 of the carrier 20 form a gap 80 therebetween, so that the carrier 20 can be stably held without rocking due to suitable friction provided by the projection portions 43, and the carrier 20 will not be frictionally restrained to be not rotatable. As a result, according to various requirements (such as two edges of a wall perpendicular to each other, or the like), the orientation of an outlet 71 of the caulk cartridge 70 is positionably orientated in a specific angle (see FIGS. 4 and 5). It is noted that, at least one washer may be further disposed between the spacing portion 40 and the axially-facing wall 22 of the carrier 20, or the tubular body 33 may be not disposed through the through hole of the carrier 2, and the tubular body 33 abuts against the axially-facing wall 22.

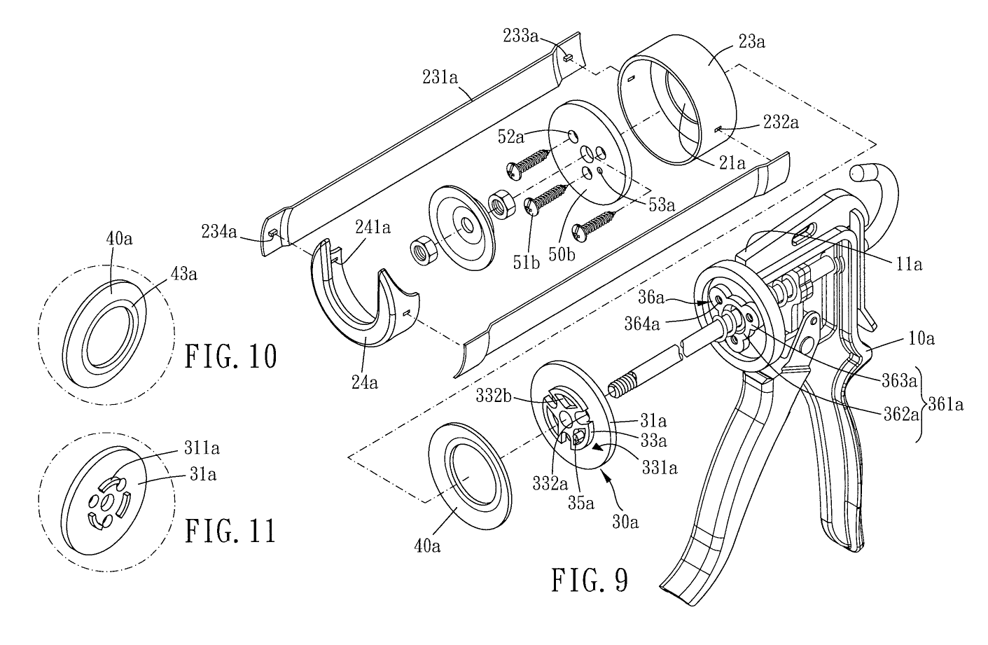

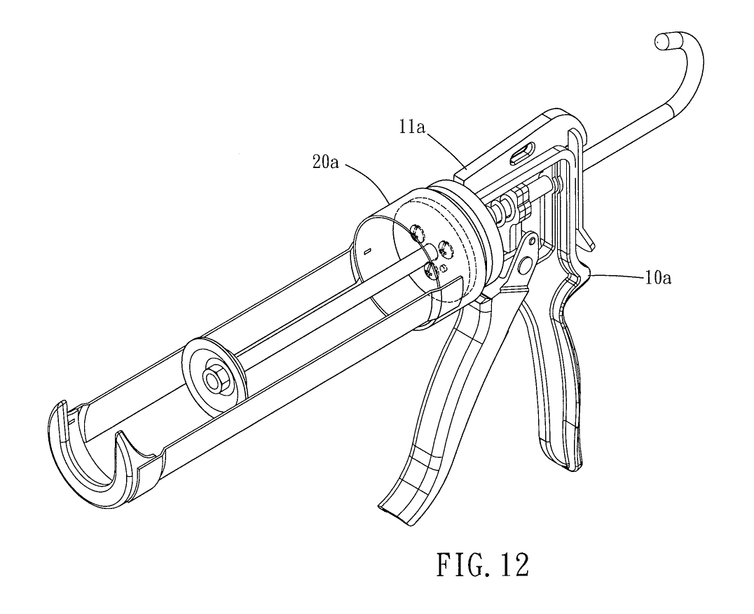

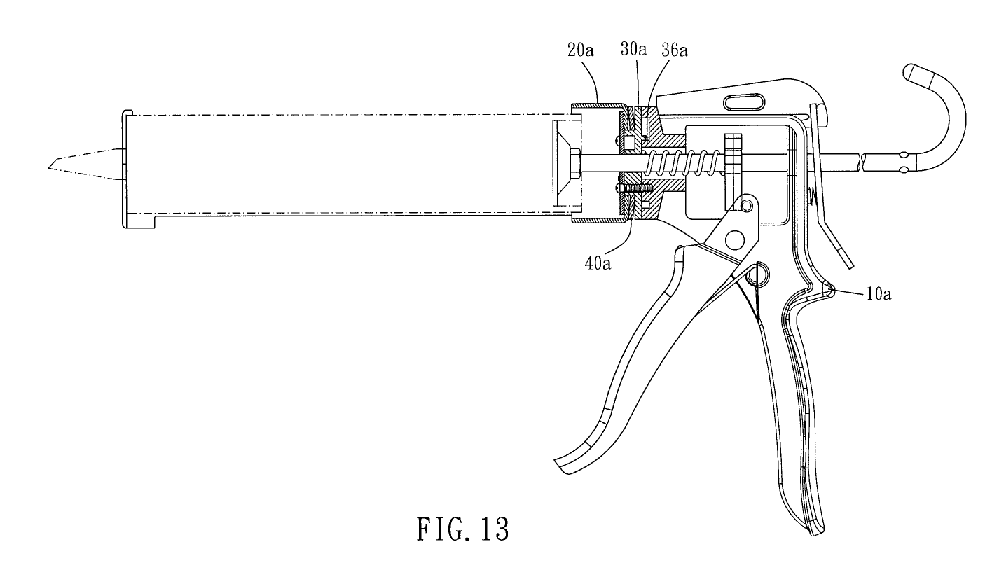

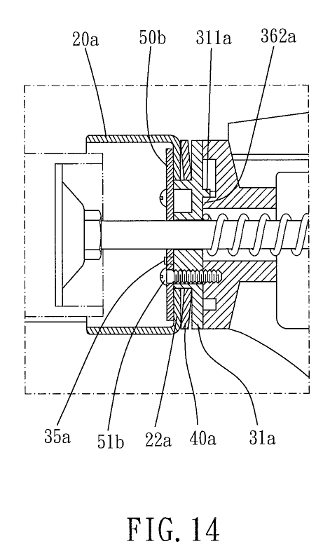

In a third embodiment as shown in FIGS. 9-14, the spacing portion 40a includes an annular projection portion 43a, and the annular projection portion 43a is configured to be abutted between the gun body 10a and the carrier 20a in such a manner that the gun body 10a and the carrier 20a are rotatable relative to each other.

The seat portion 30a further includes an axial projection portion 33a which is disposed on the seat wall 31a and configured to be disposed within the a through hole 21a of the carrier 20a, the annular projection portion 43a is disposed around the axial projection portion 33a, and the annular projection portion 43a is configured to be abutted between the seat wall 31a and the carrier 20a. The spacing portion 40a is a ring plate disposed around the axial projection portion 33a.

The seat portion 30a further includes a plurality of voids. The plurality of voids include a plurality of through holes 332a penetrating through the axial projection portion 33a and the seat wall 31a and being radially open on the axial projection portion 33a. The plurality of voids further include a plurality of blind holes 332b, and the plurality of blind holes 332b and the plurality of through holes 332a are annularly alternatively arranged on the axial projection portion 33a.

The assembly for the carrier 20a of the caulking gun further includes a clamp member 50b and at least one fastener 51b, the clamp member 50b and the spacing portion 40a are configured to be disposed by two side of an axially-facing wall 22a of the carrier 20a, and each fastener 51b is disposed through the clamp member 50b and one of the through holes 332a and is configured to be fixed to the gun body 10a. The clamp member 50b includes a plurality of penetrating holes 52a, each fastener 51b is disposed through one of the plurality of through holes 332a and one of the plurality of penetrating holes 52a. The clamp member 50b further includes a positioning hole 53a, and the axial projection portion 33a further includes a boss 35a disposed within the positioning hole 53a.

The assembly for the carrier 20a of the caulking gun further includes a seat base 36a configured to be integrated with the gun body 10a, the seat wall 31a includes a plurality of arced ribs 311a, the seat base 36a includes an axial protrusion 361a having a plurality of circumferential arced flanges 362a connected between a plurality of blocking portions 363a, and the plurality of arced ribs 311a radially correspond to the plurality of circumferential arced flanges 362a and are circumferentially located between the plurality of blocking portions 363a, respectively, thus preventing free rotation of the seat wall 31a relative to the seat base 36a.

The plurality of blocking portions 363a each have a fixation hole 364a in which the fastener 51b is fixedly engaged. The axial projection portion 33a further includes an index 331a configured to be referred to a reference portion 11a (may be a mark) of the gun body 10a for alignment of the plurality of through holes 332a, the plurality of penetrating holes 52a and the fixation holes 364a of the plurality of blocking portions 363a.

The carrier 20a of the caulking gun includes a tubular member 23a which has the axially-facing wall 22a and near the seat portion 30a and two side plates 231a which extend axially from the tubular member 23a, the annular projection portion 43a is abutted between the seat wall 31a and the axially-facing wall 22a, the tubular member 23a further includes two engaging grooves 232a, and the two side plates 231a each further include a projection 233a which is engaged into one of the two engaging grooves 232a. The carrier 20a of the caulking gun further includes a bracket 24a away from the seat portion 30a, and the two side plates 231a which extend axially from the bracket 24a toward the seat portion 30a, the bracket 24a further includes two engaging grooves 241a, and the two side plates 231a each further include a projection 234a which is engaged into one of the two engaging grooves 241a.

In this embodiment, the annular projection portion 43a is abutted between the seat wall 31a and the axially-facing wall 22a, the axially-facing wall 22a is coated with paint, the spacing portion 40a is an elastic plastic member, and the seat portion 30a is a rigid plastic member relative to the elastic plastic member. As a result, friction between the axially-facing wall 22a and the spacing portion 40a is greater than that between the spacing portion 40a and the seat portion 30a, so that the spacing portion 40a can rotatably slide on the seat wall 31a and damage to the paint coated on the axially-facing wall 22a is avoided.

It is noted that the projection portion may contact the seat portion or the carrier, the projection portion may be additionally attached to or integrally formed as a part of the seat portion, or the projection portion may be additionally attached to or integrally formed as a part of the carrier.

Given the above, through the projection portion of the assembly for a carrier of a caulking gun, the carrier and the gun body can be stably connected with each other without rocking, and the carrier is allowed to be orientationally rotated and frictionally positioned.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An assembly for a carrier of a caulking gun, for disposing between a gun body of the caulking gun and a carrier for carrying a caulk cartridge, including:
a seat portion, including a seat wall, for being connected between the gun body and the carrier;
a spacing portion, including an annular projection portion, the annular projection portion configured to be abutted between the gun body and the carrier in such a manner that the gun body and the carrier are rotatable relative to each other.

2. The assembly for the carrier of the caulking gun of claim 1, wherein the seat portion further includes an axial projection portion which is disposed on the seat wall and configured to be disposed within the a through hole of the carrier, the annular projection portion is disposed around the axial projection portion, and the annular projection portion is configured to be abutted between the seat wall and the carrier.

3. The assembly for the carrier of the caulking gun of claim 2, wherein the spacing portion is a ring plate disposed around the axial projection portion.

4. The assembly for the carrier of the caulking gun of claim 2, wherein the seat portion further includes a plurality of voids.

5. The assembly for the carrier of the caulking gun of claim 4, wherein the plurality of voids include a plurality of through holes penetrating through the axial projection portion and the seat wall and being radially open on the axial projection portion.

6. The assembly for the carrier of the caulking gun of claim 5, wherein the plurality of voids further include a plurality of blind holes, and the plurality of blind holes and the plurality of through holes are annularly alternatively arranged on the axial projection portion.

7. The assembly for the carrier of the caulking gun of claim 5, further including a clamp member and at least one fastener, wherein the clamp member and the spacing portion are configured to be disposed by two side of an axially-facing wall of the carrier, and each fastener is disposed through the clamp member and one of the through holes and is configured to be fixed to the gun body.

8. The assembly for the carrier of the caulking gun of claim 7, wherein the clamp member includes a plurality of penetrating holes, each fastener is disposed through one of the plurality of through holes and one of the plurality of penetrating holes.

9. The assembly for the carrier of the caulking gun of claim 7, wherein the clamp member further includes a positioning hole, and the axial projection portion further includes a boss disposed within the positioning hole.

10. The assembly for the carrier of the caulking gun of claim 1, further including a seat base configured to be integrated with the gun body, wherein the seat wall includes a plurality of arced ribs, the seat base includes an axial protrusion having a plurality of circumferential arced flanges connected between a plurality of blocking portions, and the plurality of arced ribs radially correspond to the plurality of circumferential arced flanges and are circumferentially located between the plurality of blocking portions, respectively.

11. The assembly for the carrier of the caulking gun of claim 8, further including a seat base configured to be integrated with the gun body, wherein the seat wall includes a plurality of arced ribs, the seat base includes an axial protrusion having a plurality of circumferential arced flange connected between a plurality of blocking portions, the plurality of arced ribs radially correspond to the plurality of circumferential arced flanges and are circumferentially located between the plurality of blocking portions, respectively, the plurality of blocking portions each have a fixation hole in which the fastener is fixedly engaged.

12. The assembly for the carrier of the caulking gun of claim 11, wherein the axial projection portion further includes an index configured to be referred to a reference portion of the gun body for alignment of the plurality of through holes, the plurality of penetrating holes and the fixation holes of the plurality of blocking portions.

13. A caulking gun, including the assembly for the carrier of the caulking gun of claim 1, further including:
a gun body;
a carrier, rotatably connected with the gun body through the assembly for the carrier of the caulking gun, the carrier being rotatable relative to the annular projection portion;
a push rod, movably connected to the gun body, disposed through the assembly for the carrier of the caulking gun, extending into the carrier.

14. The caulking gun of claim 13, wherein the carrier includes a tubular member which has an axially-facing wall and near the seat portion and two side plates which extend axially from the tubular member, the annular projection portion is abutted between the seat wall and the axially-facing wall, the tubular member further includes two engaging grooves, and the two side plates each further include a projection which is engaged into one of the two engaging grooves.

15. The caulking gun of claim 13, wherein the carrier includes a bracket away from the seat portion and two side plates which extend axially from the bracket toward the seat portion, the bracket further includes two engaging grooves, and the two side plates each further include a projection which is engaged into one of the two engaging grooves.

16. The caulking gun of claim 13, wherein the carrier includes a tubular member which has an axially-facing wall, the annular projection portion is abutted between the seat wall and the axially-facing wall, the axially-facing wall is coated with paint, the spacing portion is an elastic plastic member, and the seat portion is a rigid plastic member relative to the elastic plastic member.
